(19) United States
(12) Patent Application Publication
(10) Pub. No.: US 2007/0103130 A1
(43) Pub. Date: May 10, 2007

(54) DC-DC converter and organic light emitting display using the same

(76) Inventor: Dong Yong Shin, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/591,918

(22) Filed: Nov. 2, 2006

(30) Foreign Application Priority Data
Nov. 7, 2005 (KR) 10-2005-106170

(51) Int. Cl. G05F 1/00

(52) U.S. Cl. 323/280

(57) ABSTRACT

A DC-DC converter with improved response characteristics and reduced power consumption, and an organic light-emitting display using the converter is disclosed. The converter uses a comparator for receiving an input voltage and a reference voltage and determining an output corresponding to a difference between the input voltage and the reference voltage the converter has a feedback circuit which improves circuit performace characteristics such as gain, speed, and output voltage levels.

### CROSS-REFERENCE TO RELATED APPLICATIONS

This application claims the benefit of Korean Patent Application No. 2005-0106170, filed on Nov. 7, 2005, in the Korean Intellectual Property Office, the disclosure of which is incorporated herein by reference.

### BACKGROUND OF THE INVENTION

1. Field of the Invention

The present invention relates to a DC-DC converter and an organic light-emitting display using the same, and more specifically to a DC-DC converter configured to output a voltage according to a comparison result obtained by comparing an input voltage with a reference voltage; and an organic light-emitting display using the same.

2. Description of the Related Technology

FIG. 1 is a circuit diagram showing a previous comparator. Referring to FIG. 1, the comparator includes an input unit and first, second and third inverters.

The input unit has a first switch SW1 for switching transmission of the input voltage Vin; and a second switch SW2 for switching transmission of a reference voltage Vref.

The first inverter has a first transistor M1 as the P MOS transistor and a second transistor M2 as the N MOS transistor. And the first power supply Vdd is connected to a source of the first transistor M1 to supply a high level of voltage, and the second transistor M2 has a source connected to a ground GND to supply a low level of voltage. And, the first capacitor C1 and the third switch SW3 are connected to the first node N1.

The second inverter has a third transistor M3 as the P MOS transistor and a fourth transistor M4 as the N MOS transistor. And the first power supply Vdd is connected to a source of the third transistor M1 to supply a high level of voltage, and a ground is connected to a source of the fourth transistor M4 to supply a low level of voltage. And, the second inverter is connected with the first inverter through the second capacitor C2, and terminals of the second capacitor C2, the fourth switch M4, and the third and fourth transistors M3,M4 are connected to the second node N2.

The third inverter has a fifth transistor M5 as the P MOS transistor and a sixth transistor M6 as the N MOS transistor. And the first power supply Vdd is connected to a source of the fifth transistor M5 to supply a high level of voltage, and a ground is connected to a source of the sixth transistor M6 to supply a low level of voltage.

FIG. 2 is a timing diagram showing input/output waveforms of the circuit shown in FIG. 1. Referring to FIG. 2, an input voltage Vin input at an input terminal of a comparator unit changes in a voltage level and is compared with the reference voltage Vref. The first to fifth switches SW1 to SW5 conduct a switching operation according to the first control signal P1 and the second control signal P2, where the first, third and fourth switches SW1, SW3, SW4 are operated according to the first control signal P1 and the second and fifth switches SW2, SW5 are operated by the second control signal P2.

Firstly, if the first, third and fourth switches SW1, SW3, SW4 are turned on by the first control signal P1 and the second and fifth switches SW2,SW5 are turned off by the second control signal P2, then the input voltage Vin is transmitted to the first capacitor C1, and the voltage corresponding to a threshold voltage difference between the first inverter and the second inverter is stored in the second capacitor C2.

And, if the first, third and fourth switches SW1, SW3, SW4 are subsequently turned off by the first control signal P1 and the second and fifth switches SW2, SW5 are turned on by the second control signal P2, then the reference voltage Vref is transmitted to the first capacitor C1 to compare the input voltage Vin with the reference voltage Vref.

At this time, if the input voltage Vin is higher than the reference voltage Vref, then an output port of the third inverter outputs a low level of voltage, and if the input voltage Vin is lower than the reference voltage Vref, then an output port of the third inverter outputs a high level of voltage.

In the comparator described above, the output voltage is determined according to a difference between the reference voltage Vref and the input voltage Vin in the first capacitor C1, and therefore the comparator has a problem in that it takes more time to change the output voltage into the high level or the low level if there is not a high difference between the reference voltage Vref and the input voltage Vin than if there is a high difference between the reference voltage Vref and the input voltage Vin.

In order to address the problem, the comparator as described above can have a large capacitance, and therefore it has a problem because its power consumption is increased due to a large consumption of the current.

### SUMMARY OF CERTAIN INVENTIVE ASPECTS

Accordingly, certain embodiments solve such drawbacks of the device described above, and therefore can provide a DC-DC converter capable of improving a response time characteristic of the signal and also reducing power consumption.

One embodiment is a comparator configured to receive an input voltage and a reference voltage and to determine an output corresponding to a difference between the input voltage and the reference voltage. The comparator includes an input unit configured to transmit the input voltage to a first stage and to transmit the reference voltage to a second stage, and an amplification unit including a first capacitor configured to store the input voltage and the reference voltage, a second capacitor connected to the first capacitor and configured to receive and to store a feedback voltage, and at least one inverter configured to output signals corresponding to the voltage stored in the first capacitor and the second capacitor. The comparator also includes a feedback unit configured to receive a first voltage output from within the amplification unit to generate a first voltage when the input voltage is transmitted to the amplification unit, to receive a second voltage output from within the amplification unit to generate a second voltage when the reference voltage is transmitted to the amplification unit, to generate a feedback voltage corresponding to a difference between the first voltage and the second voltage, and to transmit the feedback voltage to the amplification unit, and an output unit configured to receive and to output a voltage corresponding to the output voltage of the amplification unit.

Another embodiment is a DC-DC converter including a charge pump including a voltage output terminal configured to vary and output an output voltage according to an input voltage, and a comparator configured to receive a comparator input voltage and a reference voltage, and to determine an output voltage corresponding to a difference between the comparator input voltage and the reference voltage. The comparator includes an input unit configured to supply the input voltage to a first stage and to supply the reference voltage to a second stage, a first capacitor configured to store the input voltage and the reference voltage, a second capacitor connected to the first capacitor and configured to receive and to store a feedback voltage, and at least one inverter configured to output signals corresponding to the voltage stored in the first capacitor and the second capacitor. The DC-DC converter also includes a feedback unit configured to receive a first voltage output from within the amplification unit to generate a first voltage when the input voltage is supplied to the amplification unit, to receive a second voltage output from within the amplification unit to generate a second voltage when the reference voltage is supplied to the amplification unit, to generate a feedback voltage corresponding to a difference between the first voltage and the second voltage, and to supply the feedback voltage to the amplification unit, and an output unit configured to receive and to output a voltage corresponding to the output voltage of the amplification unit.

Another embodiment is a organic light-emitting display including a pixel unit configured to display an image corresponding to data signals and scan signals, a data driving unit configured to supply the data signals to the pixel unit, a scan driving unit configured to supply the scan signals to the pixel unit, and a DC-DC converter configured to supply a power supply to the pixel unit, the data driving unit and the scan driving unit. The DC-DC converter includes a charge pump including a voltage output terminal configured to vary and output an output voltage according to an input voltage, and a comparator configured to receive a comparator input voltage and a reference voltage, and to determine an output voltage corresponding to a difference between the comparator input voltage and the reference voltage. The comparator includes an input unit configured to supply the input voltage to a first stage and to supply the reference voltage to a second stage, a first capacitor configured to store the input voltage and the reference voltage, a second capacitor connected to the first capacitor and configured to receive and to store a feedback voltage, and at least one inverter configured to output signals corresponding to the voltage stored in the first capacitor and the second capacitor. The DC-DC converter also includes a feedback unit configured to receive a first voltage output from within the amplification unit to generate a first voltage when the input voltage is supplied to the amplification unit, to receive a second voltage output from within the amplification unit to generate a second voltage when the reference voltage is supplied to the amplification unit, to generate a feedback voltage corresponding to a difference between the first voltage and the second voltage, and to supply the feedback voltage to the amplification unit, and an output unit configured to receive and to output a voltage corresponding to the output voltage of the amplification unit.

Another embodiment is a comparator configured to receive an input voltage and a reference voltage and to determine an output corresponding to a difference between the input voltage and the reference voltage. The comparator includes an input unit configured to transmit the input voltage to a first stage and to transmit the reference voltage to a second stage, an amplification unit, a feedback unit configured to receive a first voltage output from within the amplification unit to generate a first voltage when the input voltage is transmitted to the amplification unit, to receive a second voltage output from within the amplification unit to generate a second voltage when the reference voltage is transmitted to the amplification unit, to generate a feedback voltage corresponding to a difference between the first voltage and the second voltage, and to transmit the feedback voltage to the amplification unit, and an output unit configured to receive and to output a voltage corresponding to the output voltage of the amplification unit.

### BRIEF DESCRIPTION OF THE DRAWINGS

These and/or other aspects and advantages will become apparent and more readily appreciated from the following description of certain embodiments, taken in conjunction with the accompanying drawings of which:

FIG. 1 is a circuit diagram showing a previous comparator;

FIG. 2 is a timing diagram showing input/output waveforms of the circuit shown in FIG. 1;

FIG. 3 is a schematic view showing a configuration of an organic light-emitting display;

FIG. 4 is a schematic view showing a DC-DC converter used in the organic light-emitting display shown in FIG. 3;

FIG. 5 is a circuit diagram showing an embodiment of the comparator used in the DC-DC converter shown in FIG. 4;

FIG. 6 is a circuit diagram showing another embodiment of the comparator used in the DC-DC converter shown in FIG. 4;

FIG. 7 is a timing diagram showing the input/output waveforms of the comparator shown in FIGS. 5 and 6;

FIG. 8 is a characteristic curve showing an output property of the comparator shown in FIGS. 5 and 6;

FIG. 9 is a circuit diagram showing another embodiment of the comparator used in the DC-DC converter shown in FIG. 4; and

FIG. 10 is a timing diagram showing the input/output waveform of the comparator shown in FIG. 9.

### DETAILED DESCRIPTION OF CERTAIN INVENTIVE EMBODIMENTS

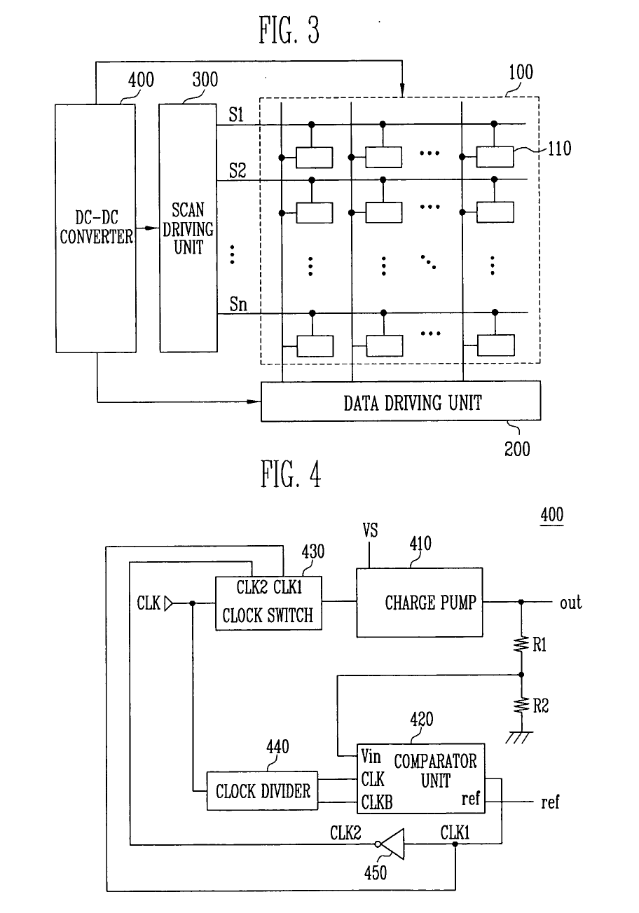

FIG. 3 is a schematic view showing a configuration of an organic light-emitting display according to some embodiments. Referring to FIG. 3, the organic light-emitting display has a pixel unit 100, a data driving unit 200, a scan driving unit 300 and a DC-DC converter 400.

In the pixel unit 100, a plurality of data lines D1 to Dm and a plurality of scan lines S1 to Sn cross each other, and pixels 110 are formed in region in which the data lines D1 to Dm and the scan lines S1 to Sn cross. The pixels 110 present an image by displaying a grey level corresponding to data signals transmitted through the data lines D1 to Dm and scan signals transmitted through the scan lines S1 to Sn.

The data driving unit 200 is connected with a plurality of the data lines D1 to Dm to transmit data signals to a plurality of the data lines in parallel, and to simultaneously transmit data signals to a pixel row arranged in a latitudinal direction of the pixel unit 100.

The scan driving unit is connected with a plurality of the scan lines S1 to Sn to transmit scan signals to a specific pixel 110 by transmitting the scan signals to the pixel 110 to which the scan signals to be transmitted.

The DC-DC converter 400 converts a D.C. power supply level, transmitted from the outside, to a suitable D.C. power supply level for each electrical loads and transmits the D.C. power level to each of the electrical loads, and the D.C. power level generated in the DC-DC converter 400 is transmitted to the pixel unit 100, the data driving unit 200 and the scan driving unit 300, etc.

FIG. 4 is a schematic view showing an embodiment of a DC-DC converter used in the organic light-emitting display shown in FIG. 3. Referring to FIG. 4, the DC-DC converter includes a clock switch 430, a charge pump 410, a clock divider 440 and a comparator 420.

The clock switch 430 receives clocks from a clock generation unit CLK, and adjusts the clocks generated in the clock generation unit CLK using the first clock CLK1 and the second clock CLK2 transmitted through the inverter 450.

The charge pump 410 synchronizes with the first clock CLK1 and the second clock CLK2, and charges a capacitor to generate a higher voltage or a lower voltage than the input voltage, and output the generated voltage to each of the driving units.

The clock divider 440 transmits the clocks CLK and CLKB from the clock generation unit CLK to the comparator unit 420 to operate the comparator unit 420.

The comparator 420 is synchronized by the clocks CLK and CLKB, and compares a reference voltage Vref with an input voltage Vin by receiving the input voltage Vin from an output port of the charge pump 410 and receiving the reference voltage Vref through the reference voltage source, and allows the clock switch 430 to be operated by the first clock CLK1 and the second clock CLK2 by transmitting the compared signals to the clock switch 430 through the inverter 450. This allows a charge pump to control an output voltage to correspond to the first clock CLK1 and the second clock CLK2.

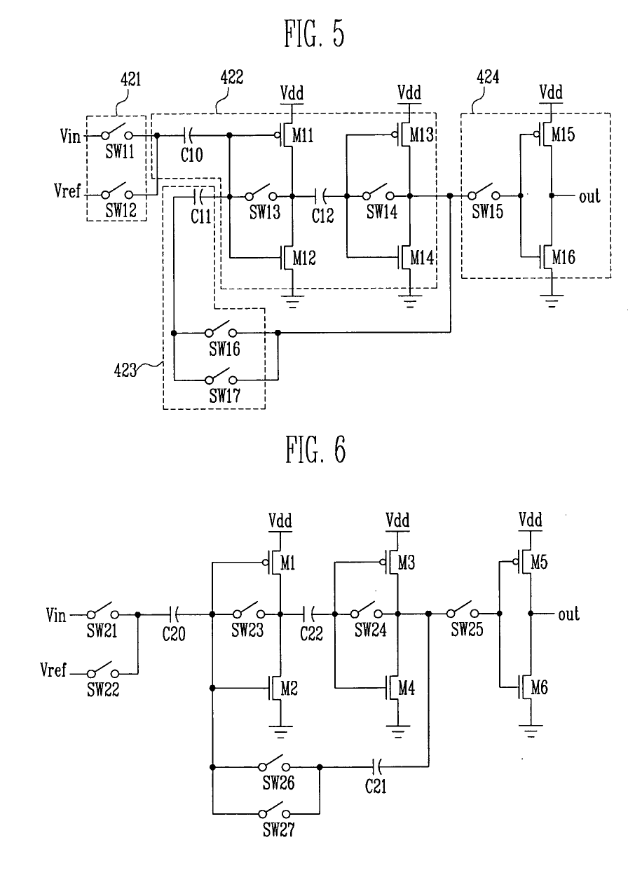

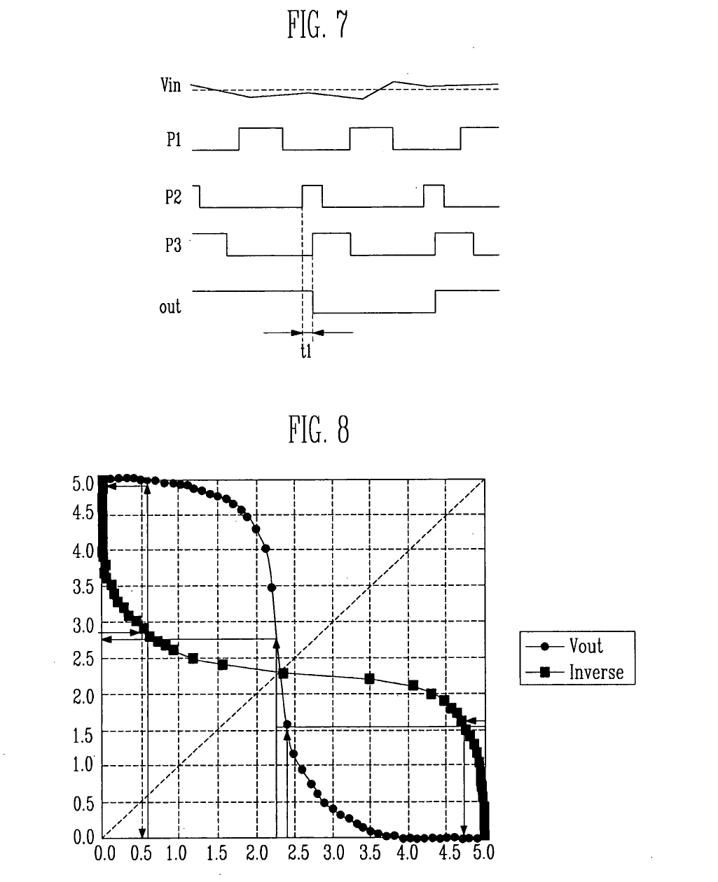

FIG. 5 is a circuit diagram showing an embodiment of the comparator used in the DC-DC converter shown in FIG. 4; and FIG. 7 is a timing diagram showing the input/output waveforms of the comparator shown in FIG. 5. Referring to FIG. 5, the comparator 420 has an input unit 421, amplification unit 422, output unit 424, feedback unit 425, and first, second and an third inverters.

Referring to FIG. 5, the input unit has an input voltage connected with the capacitor C10 through the first switch SW11, and a reference voltage Vref connected with the capacitor C10 through the second switch SW12. The capacitor C10 is connected with the gates of the first and second transistors M11 and M12 of the first inverter.

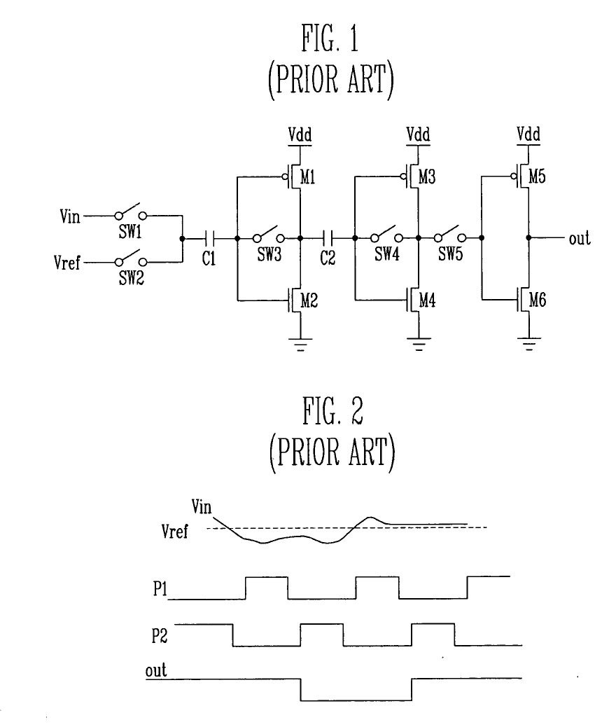

The capacitor C11 has a first electrode connected with the gates of the first and second transistors M11 and M12 of the first inverter, and a second electrode connected with a sixth switch SW16 and a seventh switch SW17. Also, the first, second, and third inverters are connected in the same manner as in FIG. 1. The sixth switch SW16 and the seventh switch SW17 are connected to the output port of the second inverter, that is, between a fourth switch SW14 and a fifth switch SW15, and therefore signals output through the output port of the second inverter are transmitted by means of switching operations of the sixth switch SW16 and the seventh switch SW17.

The comparator can be operated according to the signals shown in FIG. 7, where the first switch SW11, the third switch SW13, the fourth switch SW14 and the sixth switch SW16 conduct the switching operation according to the first control signal P1, the second switch SW12 conducts the switching operation according to the second control signal P2, and the fifth switch SW15 and the seventh switch SW17 conduct the switching operation according to the third control signal P3 in the comparator.

Operation of the comparator will be described with reference to FIGS. 5 and 7. Firstly, the first switch SW11, the third switch SW13, the fourth switch SW14 and the sixth switch SW16 are turned on by the first control signal P1, and the second switch SW12 and the fifth switch SW15 are turned off by the second control signal P2 and the third control signal P3. Accordingly, an input voltage Vin is transmitted to a capacitor C10, and the voltage corresponding to a threshold voltage difference between the first inverter and the second inverter is stored in the second capacitor C12. The third inverter is at a floating state since the fifth switch SW15 remains turned off. At this time, if the sixth switch SW16 is on, then the output signal of the second inverter is stored in the first capacitor C11 via the sixth switch SW16. If the voltage stored in the first capacitor C11 is transmitted to the first inverter via switch SW13, the output voltage of the first inverter is adjusted.

When the second switch SW12 is turned on by the second control signal P2, the voltage transmitted to the capacitor C10 is changed from the input voltage Vin to the reference voltage Vref. While the third switch SW13 is open, the voltages at the input of the first inverter is changed. As a result, the voltage transmitted to the second inverter is also changed.

When the fifth and seventh switches SW15, SW17 are turned on after a time t1 while the second switch SW12 is on, the voltage stored in the first capacitor C11 is changed according to the switching operation of the seventh switch SW17. The first transistor M11 of the first inverter and the gate voltage of the second transistor M12 receive the voltage stored in the first capacitor C11. The feedback operation of the circuit increases the output swing and the switching speed of the first, second, and consequently the third inverters.

FIG. 8 is a characteristic curve showing an output property of the comparator shown in FIG. 5. Referring to FIG. 8, Vout represents a characteristic curve of the inverter, and Inverse represents a curve in which the characteristic curve of the inverter is at a reversed state.

The characteristic curve shows that the output changes significantly around an input of 2.5V, and the response characteristics of the signal is a high signal and a low signal corresponding to the difference between the input voltage and the reference voltage. The feedback procedure affects the voltage input to the amplification unit through the voltage stored in the first capacitor to improve switching characteristics.

FIG. 6 is a circuit diagram showing another embodiment of the comparator used in the DC-DC converter shown in FIG. 4. The comparator shown in FIG. 6 has a capacitor C21 for storing a feedback voltage and is connected between the output port of the amplification unit and the sixth and seventh switches SW26 and SW27.

The voltage stored in capacitor C21 is stored according to the switching operation of the sixth and seventh switches SW36 and SW37, which may occur as shown in FIG. 7. Accordingly, the comparators shown in FIG. 5 and 6 have similar advantageous characteristics, because the voltage stored in the first capacitor C21 is transmitted to the first inverter at a similar time point.

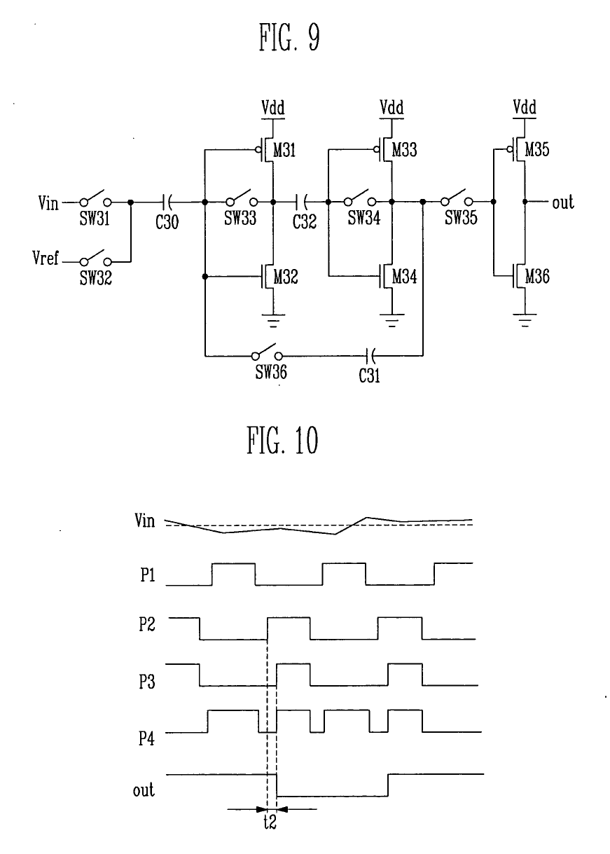

FIG. 9 is a circuit diagram showing another embodiment of the comparator used in the DC-DC converter shown in FIG. 4; and FIG. 10 is a timing diagram showing the input/output waveform of the comparator shown in FIG. 9. Referring to FIGS. 9 and 10, the comparator shown in FIG. 9 has one switch to conduct a feedback operation, unlike the comparator shown in FIGS. 5 and 6, and the switch conducting the feedback operation conducts the switching operation according to the fourth control signal P4 shown in FIG. 10.

The fourth control signal P4 is “on” when the first control signal P1 is turned on. And when the second control signal P2 is “on” to input the input voltage Vin at a time (t2) after the second control signal P2 is turned on, a voltage is charged in the first capacitor C31 according to the fourth control signal P4. As a result, the reference voltage Vin is input to the first inverter according to the second control signal P2.

Accordingly, the voltage is stored onto the first capacitor C31 of FIG. 9 similarly to the storing of voltage onto the first capacitor C11 of the comparator shown in FIG. 5. Accordingly, the comparator shown in FIG. 9 also has similar advantageous characteristics as shown in the characteristic curve of in FIG. 8.

The converter aspects described above, and the DC-DC converter and an organic light-emitting display using the converter have improved response rate because of varying the voltage input to the inverter to increase a changing level of the output voltage. Also, the DC-DC converter may reduce a power consumption by shutting off the inverter circuit to prevent flow of the current if the input/output unit is not operated.

Although certain embodiments have been shown and described in detail, the embodiments mentioned herein are examples for the purpose of illustrations only, and are not intended to limit the scope of the invention to the specific details described. Also, it would be appreciated by those skilled in the art that changes might be made in these embodiment without departing from the principles and spirit of the invention.

What is claimed is:

1. A comparator configured to receive an input voltage and a reference voltage and to determine an output corresponding to a difference between the input voltage and the reference voltage, the comparator comprising:
an input unit configured to transmit the input voltage to a first stage and to transmit the reference voltage to a second stage;
an amplification unit comprising:
a first capacitor configured to store the input voltage and the reference voltage;
a second capacitor connected to the first capacitor and configured to receive and to store a feedback voltage; and
at least one inverter configured to output signals corresponding to the voltage stored in the first capacitor and the second capacitor;
a feedback unit configured to receive a first voltage output from within the amplification unit to generate a first voltage when the input voltage is transmitted to the amplification unit, to receive a second voltage output from within the amplification unit to generate a second voltage when the reference voltage is transmitted to the amplification unit, to generate a feedback voltage corresponding to a difference between the first voltage and the second voltage, and to transmit the feedback voltage to the amplification unit; and
an output unit configured to receive and to output a voltage corresponding to the output voltage of the amplification unit.

2. The comparator according to claim 1, wherein the first stage includes a first input port configured to receive the input voltage and a first switch connected between the input port and the first capacitor, the first switch configured to switch the input voltage, and the second stage includes a second input port and a second switch connected between the second input port and the first capacitor, the second switch configured to switch the reference voltage.

3. The comparator according to claim 1, wherein the amplification unit includes at least two inverters, and a third capacitor is connected between the inverters and is configured to store a threshold voltage difference between the inverters.

4. The comparator according to claim 1, wherein the second capacitor is connected to an input port of the at least one inverter and to the first capacitor.

5. The comparator according to claim 1, wherein the second capacitor is connected between an input port of the inverter and the feedback unit.

6. The comparator according to claim 1, wherein the feedback unit is configured to supply the feedback voltage to the first capacitor, during a time when the output of the at least one inverter is output and between a time when the input voltage is supplied to the at least one inverter and the time when the reference voltage is supplied to the at least one inverter.

7. The comparator according to claim 1, wherein the input unit is configured to conduct a switching operation according to a first control signal and a second control signal, the amplification unit is configured to conduct a switching operation according to the first control signal and a third control signal; and the feedback unit is configured to conduct a switching operation according to the first control signal and the third control signal.

8. The comparator according to claim 7, wherein the feedback unit comprises a first switch configured to conduct a switching operation according to the first control signal, and a second switch configured to conduct a switching operation by the third control signal.

9. The comparator according to claim 1, wherein the input unit is configured switch according to a first control signal and a second control signal, the amplification unit is configured switch according to the first control signal and a third control signal, and the feedback unit is configured to switch according to the fourth control signal.

10. The comparator according to claim 9, wherein the feedback unit is configured to switch according to the fourth control signal.

11. The comparator according to claim 1, wherein the output unit is configured to output a high level of signal if the difference between the reference voltage and the input voltage is positive, and is configured to output a low level of voltage if the difference between the reference voltage and the input voltage is negative.

12. The comparator according to claim 1, wherein the feedback unit is configured to use the signal stored in the second capacitor corresponding to the signal stored in the first capacitor.

13. The comparator according to claim 1, wherein the amplification unit comprises at least two inverters, and a third capacitor is connected between the inverters and is configured to store a threshold voltage difference between the inverters.

14. The comparator according to claim 1, wherein the amplification unit is connected to the input unit through the first capacitor, and the first capacitor is configured to sequentially receive the input voltage supplied through the first stage, and the input voltage supplied through the second stage, wherein a voltage corresponding to the difference between the input voltage and the reference voltage is supplied to the amplification unit.

15. A DC-DC converter comprising:
a charge pump including:
a voltage output terminal configured to vary and output an output voltage according to an input voltage; and
a comparator configured to receive a comparator input voltage and a reference voltage, and to determine an output voltage corresponding to a difference between the comparator input voltage and the reference voltage,
wherein the comparator comprises:
an input unit configured to supply the input voltage to a first stage and to supply the reference voltage to a second stage;
a first capacitor configured to store the input voltage and the reference voltage;
a second capacitor connected to the first capacitor and configured to receive and to store a feedback voltage; and
at least one inverter configured to output signals corresponding to the voltage stored in the first capacitor and the second capacitor;
a feedback unit configured to receive a first voltage output from within the amplification unit to generate a first voltage when the input voltage is supplied to the amplification unit, to receive a second voltage output from within the amplification unit to generate a second voltage when the reference voltage is supplied to the amplification unit, to generate a feedback voltage corresponding to a difference between the first voltage and the second voltage, and to supply the feedback voltage to the amplification unit; and
an output unit configured to receive and to output a voltage corresponding to the output voltage of the amplification unit.

16. The DC-DC converter according to claim 15, wherein the first stage includes a first input port configured to receive the input voltage and a first switch connected between the input port and the first capacitor, the first switch configured to switch the input voltage, and the second stage includes a second input port and a second switch connected between the second input port and the first capacitor, the second switch configured to switch the reference voltage.

17. The DC-DC converter according to claim 15, wherein the amplification unit includes at least two inverters, and a third capacitor is connected between the inverters and is configured to store a threshold voltage difference between the inverters.

18. The DC-DC converter according to claim 15, wherein the second capacitor is connected to an input port of the at least one inverter and to the first capacitor.

19. The DC-DC converter according to claim 15, wherein the second capacitor is connected between an input port of the inverter and the feedback unit.

20. The DC-DC converter according to claim 15, wherein the feedback unit is configured to supply the feedback voltage, during a time when the output of the at least one inverter is output and between a time when the input voltage is supplied to the at least one inverter and the time when the reference voltage is supplied to the at least one inverter.

21. The DC-DC converter according to claim 15, wherein the input unit is configured to switch according to a the first control signal and a second control signal; the amplification unit is configured to switch according to a the first control signal and a third control signal; and the negative feedback unit is configured to switch according to the first control signal and the third control signal.

22. An organic light-emitting display comprising:
a pixel unit configured to display an image corresponding to data signals and scan signals;
a data driving unit configured to supply the data signals to the pixel unit;
a scan driving unit configured to supply the scan signals to the pixel unit; and
a DC-DC converter configured to supply a power supply to the pixel unit, the data driving unit and the scan driving unit,
wherein the DC-DC converter comprises:
a charge pump including:
a voltage output terminal configured to vary and output an output voltage according to an input voltage;
a comparator configured to receive a comparator input voltage and a reference voltage, and to determine an output voltage corresponding to a difference between the comparator input voltage and the reference voltage,
wherein the comparator comprises:
an input unit configured to supply the input voltage to a first stage and to supply the reference voltage to a second stage;
a first capacitor configured to store the input voltage and the reference voltage;
a second capacitor connected to the first capacitor and configured to receive and to store a feedback voltage; and
at least one inverter configured to output signals corresponding to the voltage stored in the first capacitor and the second capacitor;
a feedback unit configured to receive a first voltage output from within the amplification unit to generate a first voltage when the input voltage is supplied to the amplification unit, to receive a second voltage output from within the amplification unit to generate a second voltage when the reference voltage is supplied to the amplification unit, to generate a feedback voltage corresponding to a difference between the first voltage and the second voltage, and to supply the feedback voltage to the amplification unit; and
an output unit configured to receive and to output a voltage corresponding to the output voltage of the amplification unit.

23. A comparator configured to receive an input voltage and a reference voltage and to determine an output corresponding to a difference between the input voltage and the reference voltage, the comparator comprising:
an input unit configured to transmit the input voltage to a first stage and to transmit the reference voltage to a second stage;
an amplification unit;
a feedback unit configured to receive a first voltage output from within the amplification unit to generate a first voltage when the input voltage is transmitted to the amplification unit, to receive a second voltage output from within the amplification unit to generate a second voltage when the reference voltage is transmitted to the amplification unit, to generate a feedback voltage corresponding to a difference between the first voltage and the second voltage, and to transmit the feedback voltage to the amplification unit; and
an output unit configured to receive and to output a voltage corresponding to the output voltage of the amplification unit.
